(19) United States
(12) Patent Application Publication
(10) Pub. No.: US 2026/0265997 A1
(43) Pub. Date: Sep. 10, 2026

(54) SPIRALLY WOUND PRESS FELT WITH ORTHAGONAL SEAM LOOPS AND METHOD

(71) Applicant: AstenJohnson International, Inc., Charleston, SC (US)

(72) Inventors: Henry LEE, Simpsonville, SC (US); David RHODES, Simpsonville, SC (US)

(73) Assignee: AstenJohnson International, Inc., Charleston, SC (US)

(21) Appl. No.: 18/876,236

(22) PCT Filed: Jun. 28, 2023
(86) PCT No.: PCT/US2023/026420

§ 371 Date: Dec. 18, 2024

Related U.S. Application Data
(60) Provisional application No. 63/356,615, filed on Jun. 29, 2022.

(51) Int. Cl. D21F 7/10; D03D 13/00; D03D 15/47; D03D 15/60

(52) U.S. Cl. CPC D21F 7/10; D03D 13/004; D03D 15/47; D03D 15/60; D10B 2505/00

(57) ABSTRACT

A seamed press felt including a base fabric having an MD length and CD width, and including MD oriented yarns held in position by an additional fabric material component. The MD oriented yarns are arranged in the base fabric as two superimposed layers joined by bent-back regions at CD oriented fold regions at the opposing ends. The additional fabric material component is removed from the MD oriented yarns in these fold regions to form seam regions. CD yarns are interwoven across a CD width of the base fabric with the MD oriented yarns in the fold regions and form respective woven regions adjacent to seam loops formed by the bent-back regions of the MD oriented yarns at the CD fold regions. The woven regions anchor the MD oriented yarns at the fold regions such that the seam loops are formed uniformly across a CD width of the press felt.

### CROSS-REFERENCE TO RELATED APPLICATIONS

This application claims priority from PCT/US2023/026420, filed Jun. 28, 2023 and U.S. Provisional Application No. 63/356,615, filed Jun. 29, 2022, both of which are incorporated herein by reference as if fully set forth.

### FIELD OF THE INVENTION

The invention generally concerns seamed press felts for use in the manufacture of paper and similar products in a papermaking or like machine. It is particularly concerned with seams for spiral bonded felts. The novel construction assists to prevent loop stretching and provide loop anchoring.

### BACKGROUND

The present invention concerns press felts for use in the press section of papermaking machines. In the manufacture of paper products, a stock slurry consisting of about 1% papermaking fibers and other solids dispersed in about 99% water is delivered at high speed and precision from a headbox slice onto a rapidly moving forming fabric, or between two forming fabrics, in the forming section of a papermaking machine. The stock is subjected to agitation and is dewatered by various means through the forming fabrics, leaving behind a loosely cohesive and wet web of fibers. This web is then transferred to the press section where a further portion of water is removed by mechanical means as the web, supported by one or more press felts, passes through at least one, and usually a series, of press nips where water is essentially squeezed from the nascent sheet and into the press felt. The water is accepted by the press felt and, ideally, does not return to the web. The resulting sheet is then passed to the dryer section which includes a series of rotatable dryer drums, or cans, that are heated by steam. The sheet is directed around and held in contact with the periphery of these drums by one or more dryer fabrics so that the majority of the remaining water is removed by evaporation.

Press felts play a critical role in the manufacture of paper products. The known press felts are produced in a wide variety of styles designed to meet the requirements of the papermaking machines on which they are installed, and the paper grades being manufactured. They are generally assembled using a woven or nonwoven base fabric structure into which is needled one and usually multiple layers of a fibrous nonwoven batt. The batt provides a smooth surface upon which the paper product is conveyed, acts as a reservoir to trap water expressed at the press nip, and provides a measure of resiliency to the press felt as it passes through the nip. The base fabrics are typically woven from monofilament, cabled monofilament, multifilament or similar multicomponent yarns; they may also be arranged as nonwoven planar arrays. The component yarns are usually comprised of an extruded polymeric resin, typically a polyamide.

The base fabrics may be of single layer or multilayer construction, or they may be formed from two or more layers which are laminated together. They may be woven endless, so that the resulting fabric resembles a tube with no seam; such fabrics must be prepared to the length and width of the machine for which they are intended, and must be slipped onto the press section in a manner similar to a sock. An example of such a fabric is provided in U.S. Pat. No. 7,118,651. In a variant modified endless weaving technique, the weft yarns are used to form seaming loops at the widthwise fabric edges during manufacture; when installed on the papermaking machine, these yarns will be oriented in the intended machine direction (MD) allowing the fabric to be joined by bringing the loops from each side together and inserting a pin, or pintle, through the resulting channel formed by the intermeshed loops. An example of a modified endless woven fabric may be found in U.S. Pat. No. 3,815,645. The base fabrics may also be flat woven, using one or more layers of warp or weft yarns; a seam is typically formed at each end allowing the fabric to be joined on the machine. An example of a flat woven base fabric may be found in U.S. Pat. No. 7,892,402. All of the above constructions require that the base fabric be woven to the full width and length of the machine for which they are intended.

In an effort to reduce manufacturing time and costs, so-called “multiaxial fabrics” have recently been introduced for the production of press felts. Multiaxial press felts are well known and are described in U.S. Pat. Nos. 5,360,656; U.S. 5,268,076; U.S. 5,785,818 and others. The base fabrics of these press felts are comprised of a plurality of spirally wound and edgewise joined turns of a material strip including at least machine direction (MD) oriented yarns. The material strip is usually a flat woven fabric which is narrower than the width of the intended base fabric of which it is a component. It has also been proposed to use nonwoven arrays of MD yarns as the material strip component. Regardless of whether the component is woven or nonwoven, during assembly each turn of the material strip is directed about two opposing rollers such that its component MD yarns are canted at a small angle that is from about 1° to about 8° to the intended MD of the finished fabric; see prior art FIG. 1. Each successive turn of the material strip is edgewise bonded to the adjacent turn of the material strip so as to build up a continuous tube-like base fabric of desired width and length. When removed from the assembly rollers and laid flat, the tube has continuous top and bottom surfaces joined at cross-machine direction (CD) oriented fold regions at each of the two opposing ends; see prior art FIG. 2. The completed multiaxial base fabrics are typically one of a two, three or four layer construction comprising the top and bottom surfaces of the spirally wound continuous tube, and optionally at least one additional flat fabric layer, located either interior to the flattened tube, or on top of one or both exterior surfaces. The assembled base fabrics may later be provided with a seam to facilitate their installation on the machine for which they are intended.

FIG. 3 shows the two opposing edge regions of a spirally wound prior art double layer woven structure with a portion of the CD oriented yarns removed at the opposing fold regions. This exposes the MD oriented yarns of the structure so that the yarn loops may be used to form a seam in the fabric as illustrated in FIG. 4. This Figure shows a double layer fabric that has been seamed by intermeshing the yarn loops formed by the MD yarns at the fold region and inserting a pintle across the length of the channel thus provided.

For the seamed press felt, and particularly in the case of multiaxial fabric-based press felts, there are several seam related issues. These include differences in the physical characteristics of the fabric in the seam area resulting in different resiliency and different air permeability, which can result in sheet break due to lower strength of the paper sheet at the seam mark, as well as marking of the finished paper. The seam region is thus usually recognized as the most critical area of the finished fabric.

One previously proposed solution was disclosed in U.S. Pat. No. 7,381,308B2 to Albany International Corp, where they are removing cross-machine direction yarns to make a seam gap, then reweaving the cross-machine direction yarns into the fabric along the edges of the ravel area at each fold.

Further issues present in these seam constructions include loop stretching and poor seam loop stability, as well as the MD seam loops being canted in the multiaxial constructions resulting in non-uniformities and more difficult seaming.

It would be desirable to provide a press felt base fabric construction which improves upon the known stability and stretching issues at the seam, particularly for multiaxial press felt constructions.

### SUMMARY

It would be desirable to provide a seam where loops are anchored into the felt—don't pull out, extend out, slip out. The seam constructions provided herein address some or all of these issues.

In one aspect, a seamed press felt is provided comprising a base fabric having an MD length and a CD width and including at least MD oriented yarns held in position by an additional fabric material component. The MD oriented yarns are arranged in the base fabric as two superimposed layers joined by bent-back regions of the MD oriented yarns at CD oriented fold regions at each of the two opposing ends thereof. The additional fabric material component is removed from the MD oriented yarns in the CD oriented fold regions to form seam regions. Respective CD yarns are interwoven across a CD width of the base fabric with the MD oriented yarns in each of the superimposed layers in the CD oriented fold regions that form respective woven regions located adjacent to seam loops formed by the bent-back regions of the MD oriented yarns at the CD fold regions. The woven regions anchor the MD oriented yarns at the CD oriented fold regions such that the seam loops are formed uniformly across a CD width of the press felt. A pintle extends through a channel defined by intermeshing the seam loops from the two opposing ends to form a seam.

In one embodiment, the woven regions comprise an increased crimp interchange of the CD yarns with the MD oriented yarns that is preferably doubled. For example, the woven regions preferably are woven in a plain weave versus a non-woven or a weave with less interchanges, such as a twill or weave with long floats, that is used in the base fabric.

In another embodiment, the base fabric comprises a spirally wound material strip having a width that is less than the CD width of the base fabric. The spirally wound material strip can be made with a bonded nonwoven material or a woven material.

In another embodiment, the seam area is oriented at 90 degrees to a machine direction of the press felt.

A particular benefit for multiaxial (spirally wound) constructions is that the woven regions anchor the MD oriented yarns at the CD oriented fold regions such that the seam loops extend in a true machine direction of the base fabric.

In another embodiment, the diameter of the CD yarns in the woven regions is selected to maintain a consistent caliper between the body of the press felt and the seam area.

In another embodiment, at least some of the woven regions include a bi-component, at least partially meltable CD yarn adjacent to the additional fabric material component that borders the woven regions at the CD oriented fold regions.

In another embodiment, the woven regions each include at least one stuffer yarn located adjacent to the seam loops formed by the MD oriented yarns at the CD fold regions. More preferably, the at least one stuffer yarn is a multi-filament yarn.

In another embodiment, the woven regions each include at least two monofilament yarns interwoven with the MD oriented yarns.

The seamed press felt may comprise surface material strips connected to the woven regions. More preferably, the surface material strips may be connected to the woven regions by adhesive, thermal, or pressure means.

In the preferred application for press felts, batt is needled to the base fabric and the woven regions.

In another aspect, a method of producing a seamed press felt is provided, the method includes providing a base fabric formed as a tube having an MD length and CD width formed by a spirally wound material strip having a width that is less than the CD width of the base fabric and including at least MD oriented yarns held in position by an additional fabric material component; removing the additional fabric material component from the MD oriented yarns in CD regions at two opposing MD ends of the tube to form respective seam regions; interweaving respective CD yarns across a CD width of the base fabric with the MD oriented yarns in the seam regions to form respective woven regions that are adapted to be located adjacent to seam loops formed by bent-back regions of the MD oriented yarns at each of the CD fold regions in the finished seamed press felt; interweaving spacer yarns with the MD oriented yarns in a seam loop forming area between the woven regions at each of the CD fold regions; collapsing the tube such that the MD oriented yarns in the base fabric are arranged as two superimposed layers connected by the bent-back regions of the MD oriented yarns at the seam regions at the two opposing MD ends; removing the spacer yarns from the MD oriented yarns at the seam loop forming area such that the seam loops are formed uniformly across a CD width of the press felt; and inserting a pintle through a channel defined by intermeshing the seam loops from the two opposing ends to form a seam. More preferably, removing the spacer yarns from the MD oriented yarns at the seam loop forming area is done prior to collapsing the tube.

In another aspect, the method further includes stabilizing the woven regions by interweaving a bi-component, at least partially meltable CD yarn adjacent to the additional fabric material component that borders the woven regions at the CD oriented fold regions, and at least partially melting the bi-component, at least partially meltable CD yarns to anchor the woven regions to the additional fabric material component that borders the woven regions at the CD oriented fold regions.

In another aspect, the method further includes stabilizing the woven regions by using an at least partially meltable scrim.

In another aspect, the method further includes stabilizing using a heat activated adhesive layer.

In another aspect, the method further includes needling a batt to the base fabric and the woven regions at each of the CD fold regions.

The above-noted features may be used separately or in combinations with other ones of the noted features.

### BRIEF DESCRIPTION OF THE DRAWINGS

The foregoing Summary and the following detailed description and claims will be best understood when read in conjunction with the drawings which show the presently preferred embodiments of the invention. In the drawings:

FIG. 1 is an illustration showing a known spiral winding process in which a strip of relatively narrow fabric 10 is spirally wound from a feed source 20 between two opposed rolls 22, 24 to produce a desired width and length of base fabric. Each successive turn of strip 10 is bonded to that to which it is laid adjacent in the process to provide the base fabric.

FIG. 2 is a view of a known continuous tube-like base fabric 30 including opposing fold regions 32 and 34; fabric 30 may be made from successive turns of the narrow fabric 10 in the manner illustrated in FIG. 1, or it may be produced by a modified endless weaving process, a flat weaving process where opposing ends of the flat woven cloth are joined to provide a continuous tube, or it may be a nonwoven cohesive assembly of yarns oriented in the length direction around the tube.

FIG. 3 is an enlargement of the two folded edge regions 32, 34 of the base fabric 30 presented in FIG. 2 which form the seam region in the prior art fabrics shown in FIGS. 1 and 2.

FIG. 4 is a schematic illustration of the seam region in a prior art base fabric 30 such as presented in FIGS. 1 to 3 including a pintle 18 to join the seam regions of the folded ends 32, 34. This is shown prior to needling of one or more batt layers to the base fabric 30.

FIG. 5 is a top view of a seam area 40 of a multiaxial base fabric 30 of the prior art, prior to the tube being collapsed to form seam loops.

FIG. 6 is a side view of a double layer seam gap of a multiaxial base of the prior art.

FIG. 7 is a side view of the seam area of a folded double layer multiaxial base fabric of the prior art with the two ends joined and a pintle inserted in the channel formed by the seam loops.

FIG. 8 is a view similar to FIG. 7 following the needling of batt to both surfaces of the press felt according to the prior art.

FIG. 9 is a view of FIG. 8 depicting cumulative filament stretch and filament slippage inside the batt and weft at the seam loops in the press felt according to the prior art.

FIG. 10 is a front view of the seam loops as seen from the running direction in application of a multiaxial base fabric of the prior art.

FIG. 11 is a top view of a seam area of a multiaxial base fabric of the current invention with CD yarns interwoven into the seam edges.

FIG. 12 is a side view of a double layer seam gap of a multiaxial base fabric of the current invention with the CD yarns interwoven into the seam edges.

FIG. 13 is a side view of the seam area of a folded double layer multiaxial base fabric of the current invention with the CD yarns interwoven into the seam edges with the ends joined and a pintle inserted in the channel formed by the seam loops.

FIG. 14 is a front view of the seam loops as seen from the running direction for the multiaxial base fabric of the current invention with the CD yarns interwoven into the seam edges.

FIG. 15 is a top view of a seam area of nonwoven base of the prior art

FIG. 16 is a side view of a double layer seam gap of a nonwoven base fabric of the prior art.

FIG. 17 is a side view of the seam area of a folded double layer nonwoven base fabric of the prior art with the two ends joined and a pintle inserted in the channel formed by the seam loops.

FIG. 18 is a front view of the seam loops as seen from the running direction for the double layer nonwoven base fabric of the prior art.

FIG. 19 is a view of FIG. 17 following the needling of batt to both surfaces of the press felt.

FIG. 20 is a view of FIG. 19 depicting cumulative filament stretch and filament slippage inside the batt and weft at the seam loops in the press felt according to the prior art shown in FIG. 19.

FIG. 21 is a front view of the seam loops as seen from the running direction for the nonwoven base fabric of the prior art.

FIG. 22 is a top view of a seam area of a nonwoven base fabric of the current invention with the CD yarns interwoven into the seam edges.

FIG. 23 is a side view of a seam gap of a double layer nonwoven base fabric of the current invention with the CD yarns interwoven into the seam edges.

FIG. 24 is a side view of the seam area of a folded double layer nonwoven base fabric of the current invention with the CD yarns interwoven into the seam edges with the ends joined and a pintle inserted in the channel formed by the seam loops.

FIG. 25 is a front view of the seam loops as seen from the running direction of a nonwoven base fabric of the current invention with the CD yarns interwoven into the seam edges.

FIG. 26 is a view similar to FIG. 24 following the needling of batt to both surfaces of the press felt.

FIG. 27 is a front view of the seam loops as seen from the running direction for the nonwoven base fabric of the current invention with the CD yarns interwoven into the seam edges.

FIG. 28 is a top view of a seam area of multiaxial base fabric of the prior art.

FIG. 29 is a side view of a single layer seam gap of a multiaxial base fabric of the prior art.

FIG. 30 is a side view of the seam area of a folded double layer multiaxial base fabric of the prior art with the two ends joined and a pintle inserted in the channel formed by the seam loops.

FIG. 31 is a front view of the seam loops as seen from the running direction in application of a multiaxial base fabric of the prior art.

FIG. 32 is a top view of a seam area of a multiaxial base fabric of the current invention with the CD yarns interwoven into the seam edges.

FIG. 33 is a side view of a single layer seam gap of a multiaxial base fabric of the current invention with the CD yarns interwoven into the seam edges.

FIG. 34 is a side view of the seam area of a folded double layer multiaxial base fabric of the current invention with the CD yarns interwoven into the seam edges with the ends joined and a pintle inserted in the channel formed by the seam loops.

FIG. 35 is a front view of the seam loops as seen from the running direction in application of a multiaxial base fabric of the current invention with the CD yarns interwoven into the seam edges.

FIG. 36 is a side view of the seam area of a folded double layer multiaxial base fabric of the current invention with the CD yarns interwoven into the seam edges with the ends joined and a pintle inserted in the channel formed by the seam loops, with additional stitching in the seam area.

FIG. 37 is a front view of the seam loops as seen from the running direction for the multiaxial base fabric of the current invention with the CD yarns interwoven into the seam edges, with additional stitching in the seam area.

FIG. 38 is a side view of the seam area of a folded double layer nonwoven base fabric of the prior art with the two ends joined and a pintle inserted in the channel formed by the seam loops, with additional stitching in the seam area.

FIG. 39 is a front view of the seam loops as seen from the running direction in application of a nonwoven base fabric of the current invention with the CD yarns interwoven into the seam edges, with additional stitching in the seam area.

FIG. 40 is a view similar to FIG. 13 showing a thin scrim or tape in an area between the additional fabric material component and the woven regions to bind the additional fabric material component to the woven regions.

FIG. 41 is a view similar to FIG. 33 showing optional spacer yarns woven between the stuffer yarns.

FIG. 42 is a flow chart showing a method for producing a seamed press felt according to a preferred aspect of the present disclosure.

### DETAILED DESCRIPTION

Certain terminology is used in the following description for convenience only and is not limiting. The words “top,” “bottom,” “upper” and “lower” designate directions in the drawings to which reference is made. A reference to a list of items that are cited as “at least one of a, b, or c” (where a, b, and c represent the items being listed) means any single one of the items a, b, or c, or combinations thereof. “A” or “an” refer to one or more of the item noted. “MD” refers to a machine direction in the papermaking machine from the headbox to the dryer section and is the longitudinal direction of the press felt. “CD” refers to the cross-machine direction, or a direction perpendicular to the machine direction in the plane of the fabric. The term “PS” refers to the paper side surface of the fabric, which is the surface upon which the paper product is carried through the papermaking machine. “MS” refers to the machine side of the fabric and is the surface opposite to the PS. Unless otherwise specified, the term “yarn” or “yarns” refers to a continuous length of either single or cabled polymeric monofilament such as would be used in the manufacture of the base fabrics, while the term “fiber” or “fibers” refers to relatively small diameter polymeric materials such as those commonly used in batt or scrim materials which fibers have a very small dtex (mass in grams per 10,000 meters of fiber). The terms “left”, “right”, “up”, “down” are used in relation to the drawings and have the meanings usually assigned. The term “about”, unless otherwise noted, means +/−10% of the noted value. Reference to a “true” direction, such as a “true MD direction” means within +/−1% of the actual direction referenced. Additional definitions for terms used herein are as follows:

### Additional Definitions

“Press felt base fabric” or “base fabric”: a woven or nonwoven assembly of yarns provided as an endless structure or continuous loop including two superimposed layers joined (when laid flat) at two opposing fold areas, including continuous MD yarns passing around the folds. The assemblies can take the form of: a) an endless woven structure, b) a modified endless woven structure, c) a flat woven fabric folded at two locations to provide a double layer assembly, d) a fabric formed according to a multiaxial assembly process, or e) a multiaxial or non-multiaxial nonwoven structure assembled to provide any of the previous assemblies. The present invention is applicable to all of the above, but it is particularly suitable for use in both woven and nonwoven multiaxial base fabric constructions. All of the base fabrics are post processed to provide seam loops formed by bent-back regions of the MD oriented component yarns allowing the fabric to be joined and thus rendered endless. These base fabrics provide the finished press felt with the physical properties (strength, void volume, resiliency) necessary for it to survive the rigors of the machine environment in which it will be used, while providing a rugged carrier for the batt fibers.

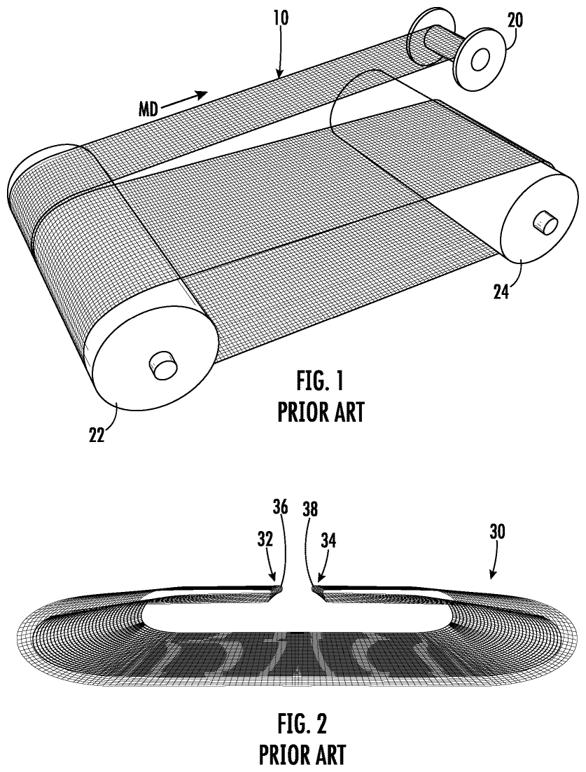

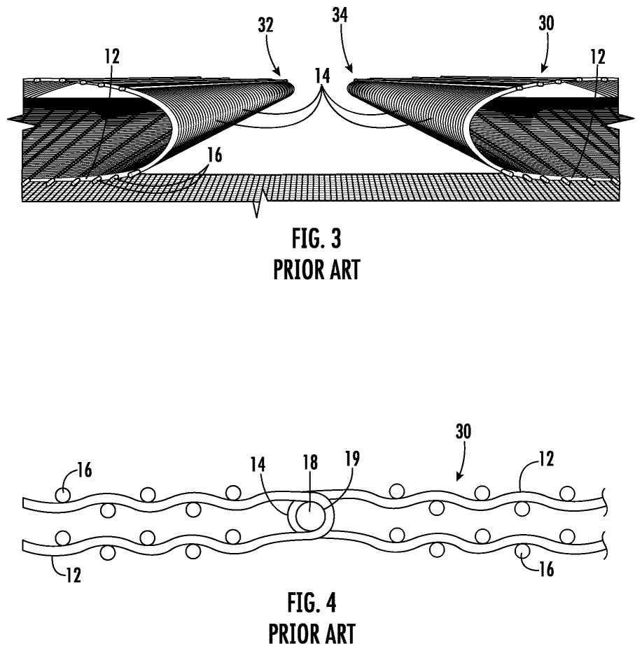

Referring to FIGS. 1-4, one construction of a press felt base fabric 30 in accordance with the prior art is shown, in this case a multiaxial construction. FIG. 1 shows a strip of material, which can be woven or non-woven and including MD oriented yarns 12 and CD oriented yarns 16, being unwound from a source 20 and wrapped around two rolls 22, 24. The longitudinal edges of the strip are joined together to form a fabric tube. FIG. 2 shows the fabric tube collapsed to form the press felt base fabric 30 having two fold regions 32, 34, that define the fabric ends 36, 38. As shown in FIG. 3, continuous ones of the MD yarns 12 form loops 14 at each of the fold regions 32, 34 at the fabric ends 36, 38 that can be intermeshed in a known manner to form a pintle channel 19 in which a pintle 18 is inserted, as shown in FIG. 4, to form an endless base fabric 30.

In the case of a multiaxial press felt base fabric 30, as well as other double layer base fabrics, the double layer formed by collapsing the fabric tube is connected together in a needling process in which one or more layers of a nonwoven fibrous batt material are attached to the base fabric 30 in a needling process to form the press felt.

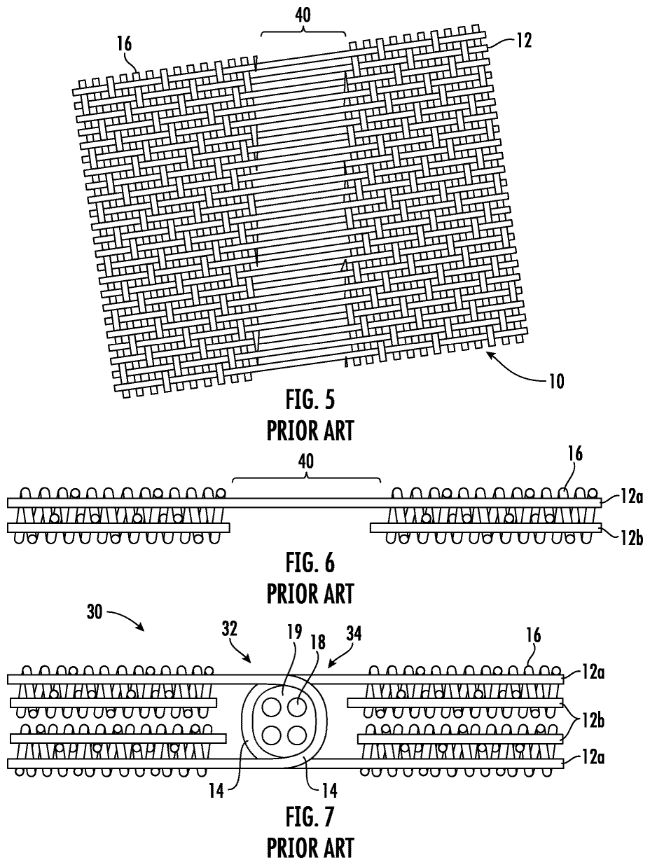

Referring to FIGS. 5-10, a further embodiment of a multi-axial press felt base fabric 30 is shown. Here, the base fabric 30 is again produced from a fabric strip 10; however, the fabric strip 10 includes two systems of MD yarns 12a, 12b that are provided in a stacked arrangement, as shown in FIG. 6. These two systems of MD yarns 12a, 12b are connected together by a system of CD oriented yarns 16 and, as shown in FIG. 5, are arranged at a canted angle to a true MD based on the multi-axial construction of the spirally wound base fabric 30. As shown in FIGS. 5 and 6, the CD oriented yarns 16 as well as a portion of the lower system of MD yarns 12b are removed in a seam area 40. As shown in FIG. 5, this results in uneven end portions of the CD oriented yarn 16 at the edges of the seam area 40.

As shown in FIG. 7, and in a similar manner to FIGS. 2-4 as discussed above, the fabric tube is collapsed to form the press felt base fabric 30 with the two fold regions 32, 34 that define the fabric ends. These fold regions have seam loops 14 formed by bent-back portions of continuous ones of the MD yarns 12a of the upper (now outer) system of MD yarns 12a. These seam loops 14 are intermeshed in a known manner to form a pintle channel 19 into which a pintle 18 is inserted in order to form an endless base fabric 30.

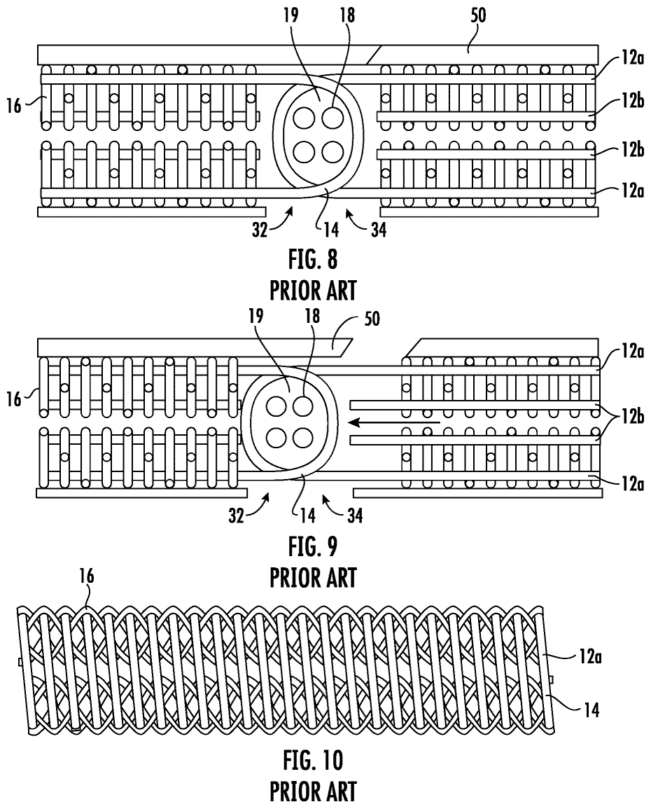

As shown in FIG. 8, one or more layers of a non-woven fibrous batt material are attached to the base fabric 30 via a needling process in order to form the prior art press felt.

As shown in FIG. 9, due to the tensile load applied to the press fabric in use, seam loop elongation can occur resulting in seam marking on the paper sheet being carried by the press felt as well as premature failure of the press felt.

FIG. 10 is an end view of the prior art base fabric which shows the seam loops 14 also at a canted angle relative to true horizontal plane defined by the press felt due to the multiaxial spirally wound construction of the base fabric 30. This also makes seaming of the known multiaxial press felt more difficult when installing the press felt onto a paper making machine.

Referring now to FIGS. 11-14, a first embodiment of a seamed press felt 100 made with a base fabric 130 according to the present invention is shown. The base fabric 130 is provided as a tube having an MD length and a CD width which is formed by a spirally wound strip of material 110 having a width that is less than the CD width of the base fabric 130 and includes MD oriented yarns, which in this case are shown as first and second systems of MD yarns 112a, 112b that are stacked over one another and held in position by an additional fabric material component 116. In this embodiment, the additional fabric material component 116 is an interwoven system of CD yarns 116.

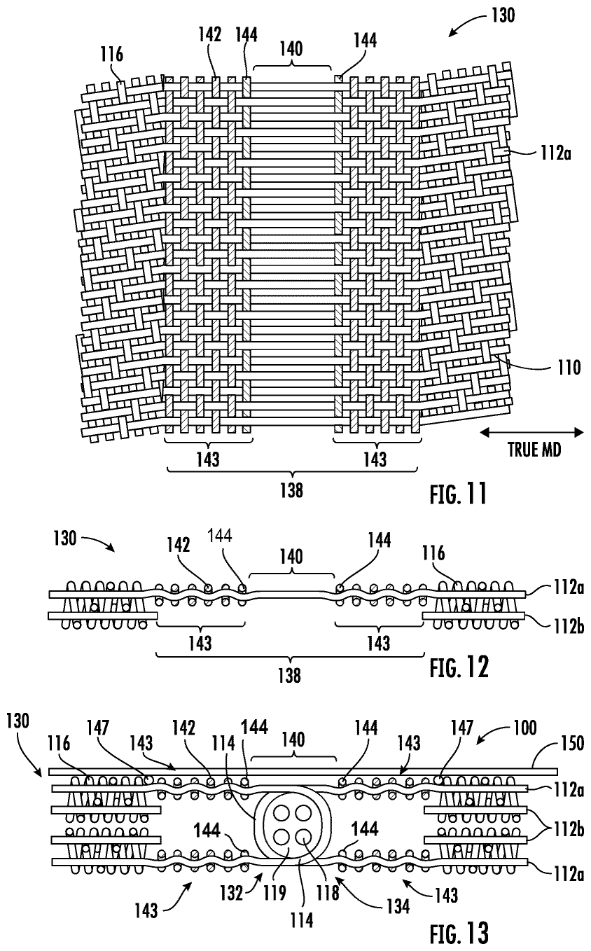

As shown in particular in FIG. 13, the MD oriented yarns 112a of the first yarn system are arranged in the base fabric 130 as to superimposed layers when the tube is collapsed that are joined by bent-back portions of the MD oriented yarns 112a at CD oriented fold regions 132, 134 at each of the two opposing ends of the base fabric. As shown in FIGS. 11 and 12, where the base fabric 130 is shown flat at what will become the CD oriented fold regions 132, 134, the additional fabric material component 116 is removed from the MD oriented yarns 112a of the first MD yarn system in the CD oriented fold regions 132, 134 to form seam regions 138. The seam region at 138 at one end of the fabric is shown in FIGS. 11 and 12, and both seam regions 138 are present in FIG. 13 when the two ends of the base fabric 130 are joined together. In addition to removing the additional fabric material component 116 in the seam regions 138, in case of the embodiment of the seamed press felt 100 in FIGS. 11-14, the lower (or inner) second system of the MD oriented yarn 112b is also removed by being cut out in the seam regions 138.

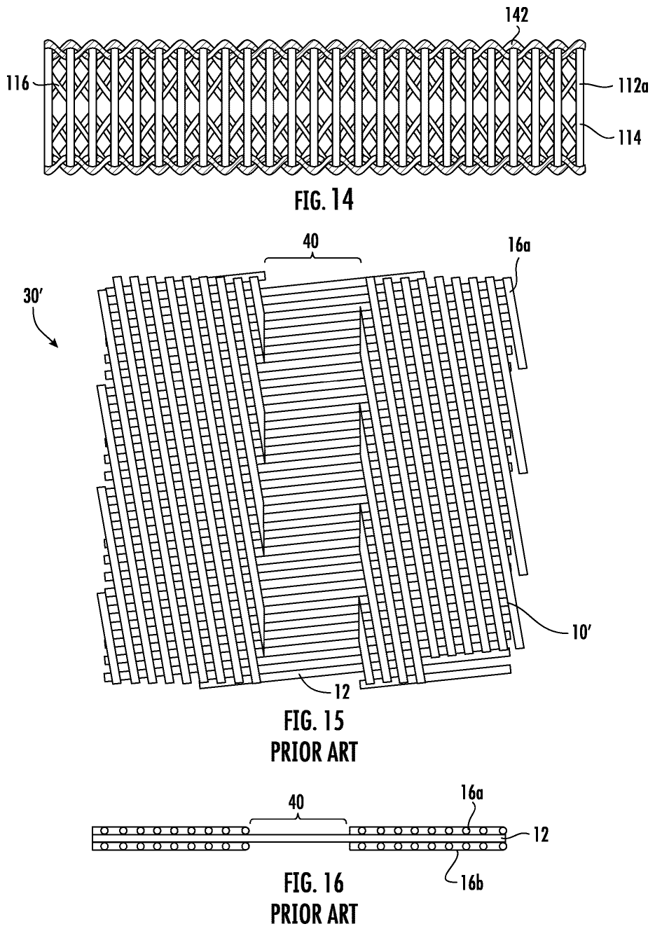

In accordance with the present invention, as shown in FIGS. 11 and 12, respective CD yarns 142 are interwoven across a CD width of the entire base fabric 130 with the MD oriented yarns 112a of the first MD oriented yarn system in each of the superimposed layers in the CD oriented fold regions 132, 134 that form respective woven regions 143 adjacent to seam loops 114 (shown in FIG. 13) formed by bent-back regions of the MD oriented yarns 112a of the first MD oriented yarn system at the CD fold regions 132, 134. These woven regions 143 anchor the MD oriented yarns 112a of the first MD oriented yarn system at the CD oriented fold regions 132, 134 such that the seam loops 114 are formed uniformly across a CD width of the press felt 100. This is shown in FIG. 14 and is also apparent from FIG. 11 where it is shown that the MD oriented yarns 112a are arranged in a true MD and are also aligned vertically relevant to a horizontal plane of the seamed press felt 100 at the seam. This is in contrast to the prior art where it is apparent from FIGS. 5 and 10 that the MD oriented seam loops 14 are tilted with respect to a true vertical and are arranged canted relative to a true MD.

Referring to FIG. 13, a pintle channel 119 is defined by intermeshing the seam loops 114 from the two opposing ends and a pintle 118 is extended through the pintle channel 119 in order to form a seam.

As shown in FIGS. 11 and 14, preferably the woven regions 143 comprise a crimp interchange of the CD yarns 142 with the MD oriented yarns 112a of the first yarn system that is greater than, and more preferably doubled, (i.e. woven in a plain weave) relative to a remainder of the base fabric 130.

While the spirally round strip of material 110 in the embodiment of the seamed press felt 100 shown in FIGS. 11-14 is formed of a woven material, it could also be formed of a bonded, non-woven material as discussed in further detail below.

Using the present construction, the seam area 140 is oriented at 90 degrees to a machine direction of the press felt and the MD yarns 112a of the first MD oriented yarn system are held at a true 90 degrees to the seam area 140, and are oriented in a true machine direction which results in easier seaming of the fabric and less distortion of the seam loops 114 as they are held by the CD yarns 142 in the woven regions 143 in the true machine direction.

In a preferred arrangement, a diameter of the CD yarns 142 in the woven regions 143 is selected to maintain a consistent caliper between a body of the press felt 100 and the seam regions 138. In a preferred arrangement, the diameter of the CD yarns 142 is +/−20% of a diameter of the CD yarns that are used to form the additional fabric material component 116 for a woven material strip 110. For a non-woven additional fabric material component 116, the size can vary depending upon the construction of the additional fabric material component 116.

Still with reference to FIGS. 11-14, optionally at least some of the woven regions 143 may include a bi-component, at least partially meltable CD yarn 147 adjacent to where the additional fabric material component 116 borders the woven regions 143 at the CD oriented fold regions 132, 134. During heat treatment, this helps to bind the cut ends of the additional fabric material component 116, which in the present embodiment is CD yarns, in this intersecting area. While this is illustrated only in FIG. 13 on the outer, paper-support surface of the press felt 100, it could also apply at the inner, machine support surface.

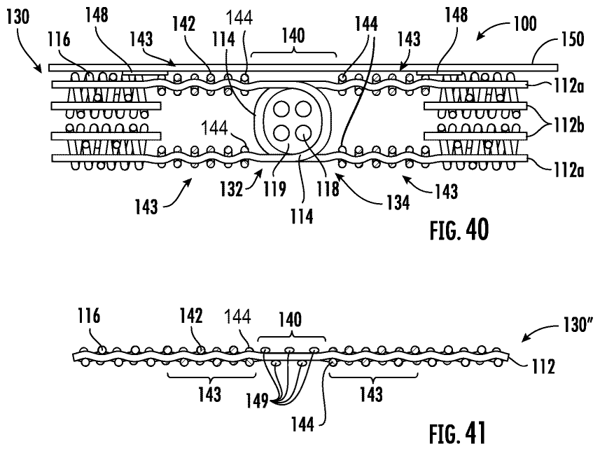

Alternatively, as shown ion FIG. 40, instead of the bi-component, at least partially meltable CD yarns 147, a thin scrim or tape 148, preferably also made of a bi-component, at least partially meltable polymeric material, could also be utilized in this area which would again act to bind the cut ends of the additional fabric material component 116, which in the present embodiment is the cut CD yarn ends, together to the woven regions 143 during heat treatment.

Still with reference FIGS. 11-13, in a preferred embodiment, the woven regions 143 may each include at least one stuffer yarns 144 located adjacent to seam loops 114 formed by the MD oriented yarns 112 at the CD oriented fold regions 132, 134. These stuffer yarns 144 are preferably multi-filament yarns and are adapted to more securely anchor the batt fiber material in the area adjacent to the seam loops 114.

While the size of the woven regions 143 can vary depending upon the particular application, at a minimum, the woven regions 143 each include at least two monofilament yarns 142 interwoven with the MD oriented yarns 112a of the first MD oriented yarn system.

As shown schematically in FIG. 13, a batt 150 is needled to the base fabric 130 and the woven regions 143 in order to form the press felt 100.

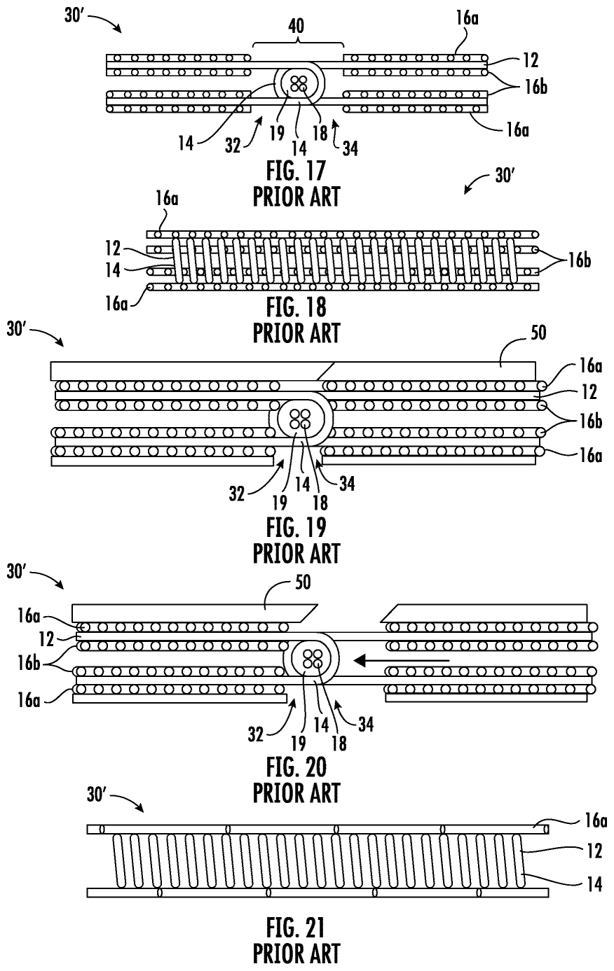

Referring now to FIGS. 15-21, a further prior art base fabric 30′ for a press felt is shown. The base fabric 30′ is similar to the base fabric 30 discussed above. However, in this case, the fabric strip 10′ used to form the multiaxially wound base fabric 30′ is formed as a non-woven structure which includes the MD oriented yarns 12 which are bonded to first and second layers of CD oriented yarns 16a, 16b. Otherwise, the structure of the base fabric 30′ is similar in that the additional fabric material component in the form of the two CD oriented yarn systems 16a, 16b is removed in the seam area 40 in order to allow formation of the seamed loops 14 from the MD yarns 12 in the area of the opposed fold regions 32, 34 as the tube of base fabric material is collapsed to form two superimposed layers. Again, fibrous batt material 50 is needled on one or both sides as shown in FIG. 19 in order to form the press felt. As shown in FIGS. 20 and 21, the seam is also subject to elongation (shown in FIG. 20) resulting in marking of the web of paper carried on the paper side surface of the press felt. Further due to the spirally wound construction, the seam loops 14 are canted with respect to a true vertical relative to the horizontal plane defined by the base fabric 30′ as shown in FIG. 21, making seaming more difficult.

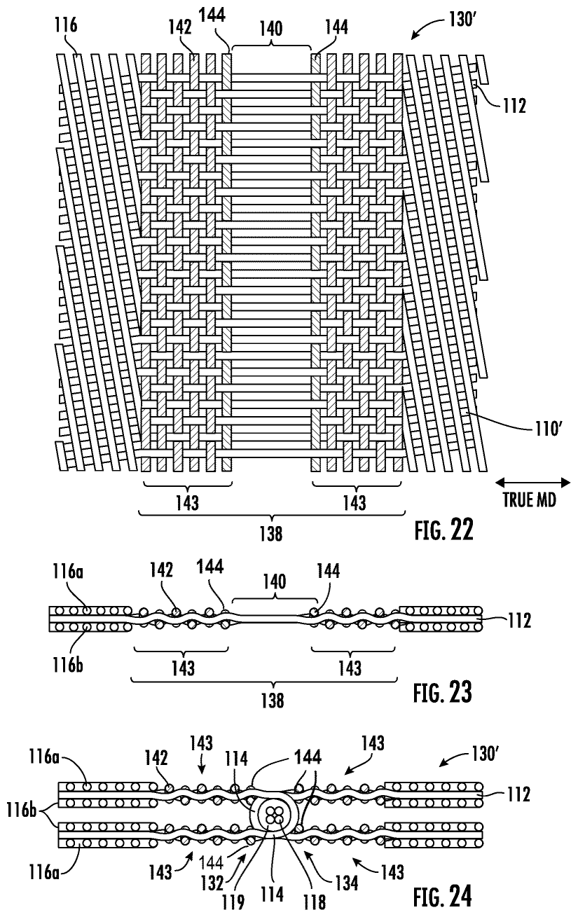

Referring now to FIGS. 22-27, a second embodiment of a seamed press felt 100′ according to the invention is shown. The second embodiment of the seamed press felt 100′ is similar to the first embodiment of the seamed press felt 100 except that the base fabric 130′ is formed with a single system of the MD oriented yarns 112 along with first and second systems of CD oriented yarns 116a, 116b as the additional fabric material component that holds the MD oriented yarns 112 in position. In this case, the first and second systems of CD oriented yarns 116a, 116b are bonded to the MD oriented yarns 112 during formation of the fabric strip 110′ that is spirally wound in order to form the base fabric 130′. Additional materials, such as an adhesive scrim (not shown) can be used for bonding the base fabric 130′ together.

As shown in FIG. 22, the first and second systems of CD oriented yarns 116a, 116b are removed in order to form the seam regions 138 at the opposing CD oriented fold regions 132, 134 at each of the ends of the base fabric 130′. Respective CD yarns 142 are interwoven across the CD width of the base fabric 130′ with the MD oriented yarns 112 in each of the two superimposed layers in the CD oriented fold regions 132, 134 to form the respective woven regions 143 that are located adjacent to the seam loops 114 formed by the bent-back regions of the MD oriented yarns 112 at the CD oriented fold regions 132, 134. In this embodiment, stuffer yarns 144 are also provided adjacent to the seam loops 114 and are interwoven at the same time as the respective CD yarns 142 prior to collapsing the spirally wound tube of material to form the base fabric 130′ having the two opposing ends that form the CD oriented fold regions 132, 134.

Here again, as shown in detail in FIGS. 24-26, these woven regions 143 anchor the MD oriented yarns 112 at the CD oriented fold regions 132, 134 such that the seam loops 114 are formed uniformly across the CD width of the press felt 100′ and are oriented vertical with respect to a horizontal surface defined by a surface of the press felt 100′ as well as being uniformly spaced and not canted when viewed looking at a surface of the base fabric 130′ due to the spirally wound construction of the base fabric 130′. The woven regions 143 formed by the respective CD yarns 142 that are interwoven across the seam width of the base fabric 130′ ensure this uniform formation of the seam loops 114 that extend in a true MD direction.

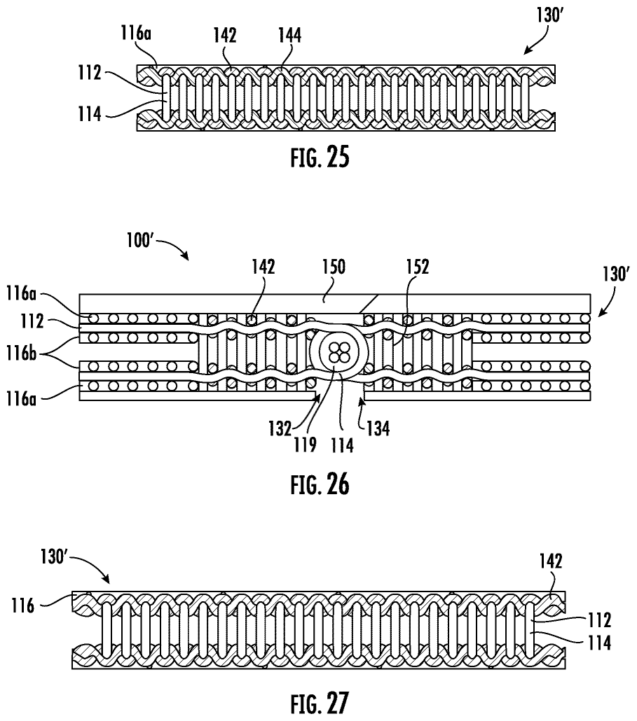

As shown in FIG. 26, a fibrous batt 150 can be needled through the base fabric 130′ with the batt fibers 152, represented schematically in FIG. 26, being punched through the base fabric 130′.

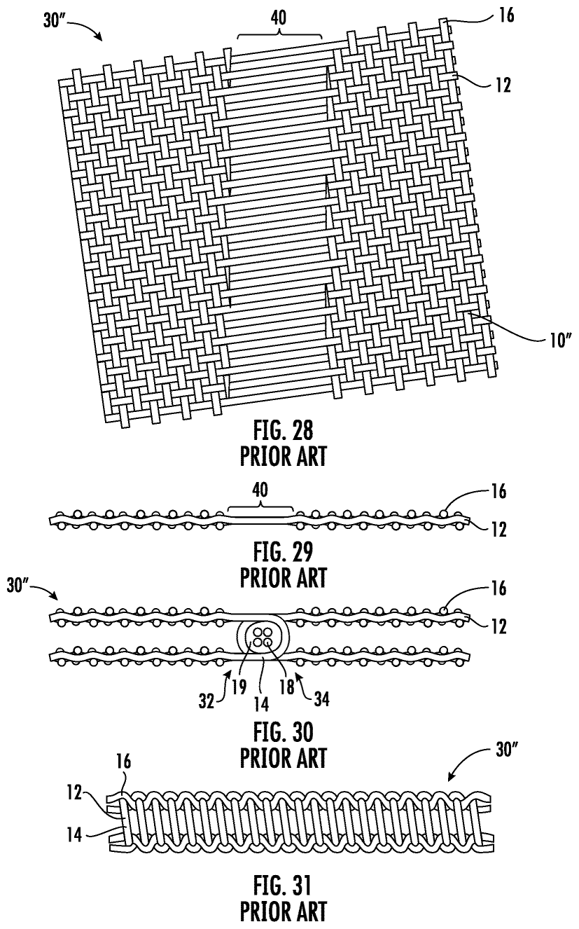

Referring now to FIGS. 28-31, a further embodiment of a prior art base fabric 30″ is shown. Here, the base fabric 30″ is formed from a plain woven material strip 10″ that includes one system of MD oriented yarns 12 that are woven with one system of CD oriented yarns 16. The construction of the base fabric 30″ is similar to the construction of the base fabric 30 discussed above and similar elements have been provided with the same element numbers. As shown in FIG. 31, this arrangement still results in the seamed loops 14 being canted as shown in FIG. 31 due to the spirally wound construction of the base fabric 30″.

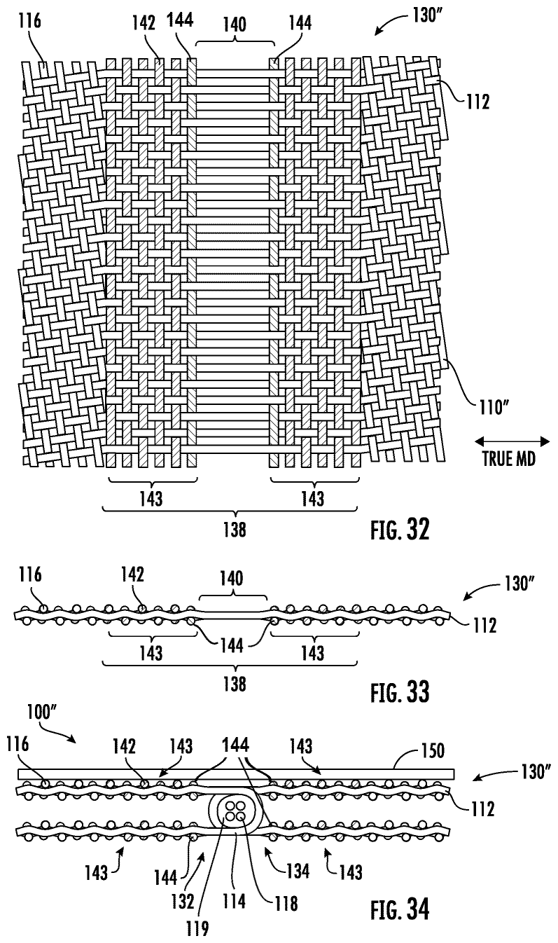

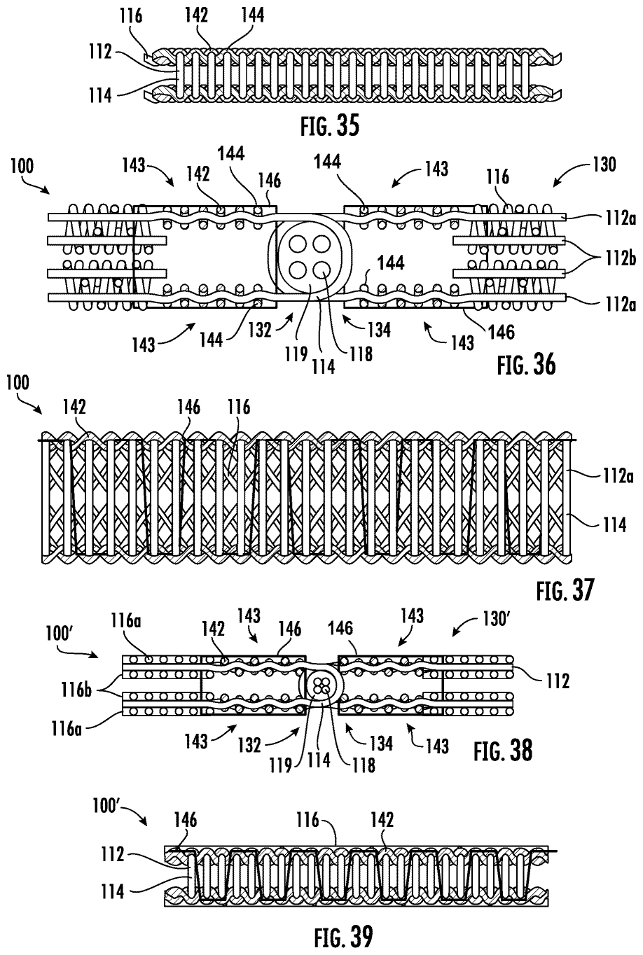

Referring now to FIGS. 32-35, a third embodiment of a seamed press felt 100″, as shown in FIG. 34, that is formed using a base fabric 130″ is illustrated. The seamed press felt 100″ is similar to the seamed press felt 100 discussed above. However, in this case, base fabric 130″ is formed by a spirally wound material strip 110″ that is a plain woven material including MD oriented yarns 112 and CD oriented yarns 116 as the additional fabric material component. Similar to the prior constructions of the seamed press felts 100, 100′ discussed above, this embodiment is similarly formed using the CD yarns 142 that are interwoven across an entire CD width of the base fabric 130″ with the MD oriented yarns 112 in the seam regions 138 where the additional fabric material component (in the form of the CD oriented yarns 116) has been removed in order to form the respective woven regions 143 adjacent to the seam loops 114. These woven regions 143 anchor the MD oriented yarns 112 at the CD oriented fold regions 132, 134 such that seam loops 114 are formed uniformly across a CD width to the press felt. As shown in FIGS. 32 and 35, the seam loops 114 extend in a true and MD direction and, in comparison to the prior art base fabric 30″ shown FIGS. 28-31, are vertical with respect to a horizontal surface defined by the base fabric 130″ and extend in the true MD.

In each of the base fabrics 130, 130′, 130″, the woven regions 143 preferably have the CD yarns 142 woven with a plain weave with the MD oriented yarns 112, 112a. The plain weave crimp provides improved MD filament anchoring to CD filaments as well as improved anchoring of batt fibers 152 of the fibrous batt 150 to woven seam base section, enhancing stability. This arrangement also further stabilizes the seam loops 114 to reduce loop stretch.

Additionally, in order to facilitate manufacture, as shown in FIG. 41, the woven regions 143 for each respective CD fold region 132, 132 can optionally be woven in one continuous weaving process with spacer yarns 149 being woven with the CD oriented yarns 116 in the area that will define the seam area 140. These spacer yarns 149 are then removed either before or after the fabric tube is collapsed to form the base fabric 130″. This would similarly apply for the base fabrics 130, 130′ described above.

Referring now to FIGS. 36 and 37, two additional views showing the press felt 100 in accordance with the first embodiment of the invention as described above are shown. In addition to the construction described above, also shown are optionally applied anchoring yarns 146 that are sewn through the woven regions 143 in order to anchor the seam loops 114 in position in the base fabric 130. These anchoring yarns 146 are stitched in position and overlap with the ends of the additional fabric material component, which in this embodiment is the CD oriented yarn system 116 in the base fabric 130.

Referring now to FIGS. 38 and 39, a similar arrangement using the optional anchoring yarns 146 stitched through the woven regions 143 and the ends of the additional fabric material component, which in this embodiment is the CD oriented yarn systems 116a, 116b in the base fabric 130′, for the press felt 100′ are shown. The function here is similar in holding the seam loops 114 in position.

The anchoring yarns could be similarly used for the base fabric 130″.

Referring now to FIG. 40, an additional view is shown similar to FIG. 13 of the press felt 100. Here, material strips 148 are used to connect the woven regions 143 to the ends of the base fabric structure of the base fabric 130 where the additional fabric material component, here in the form of a CD yarn system 116, has not been removed. The material strips 148 can be formed of an at least partially meltable scrim that melts at a heat-setting temperature for the press felt 100, 100′, 100″, similar to the at least partially meltable CD yarn 147 discussed above. While the material strips 148 are shown only partially overlapping the woven regions 143 on what would be the paper support surface of the press felt 100 in use, they could fully overlap the woven regions 143 and could also be applied on the machine side surface of the press felt 100, either partially or fully overlapping the woven regions 143 here as well. The material strips 148 could also be optionally used on the base fabrics 130′ and 130″.

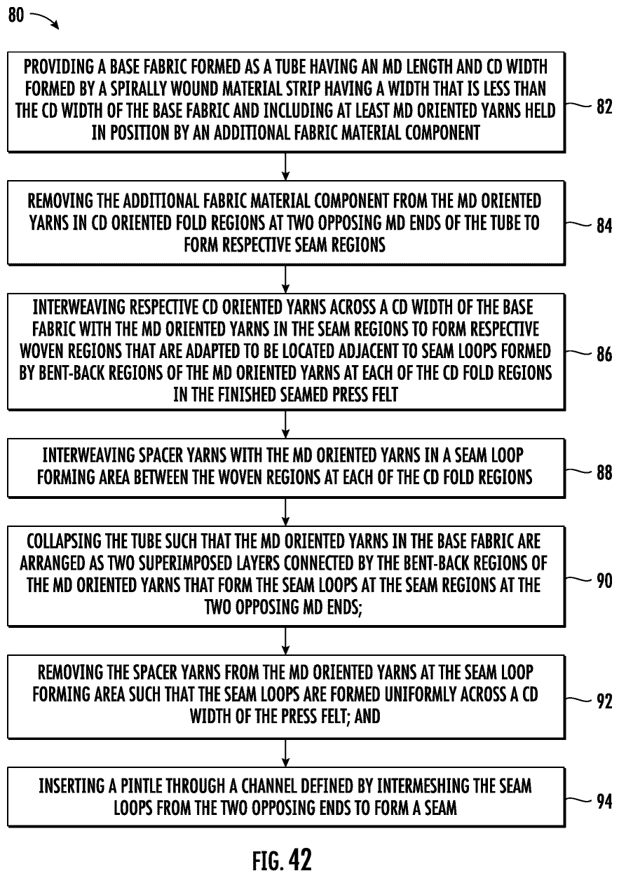

Referring now to FIG. 42, a method of producing a seamed press felt 100, 100′, 100″ will be explained in further detail with respect to the flow chart 80.

As shown in box 82, the method includes providing a base fabric 130, 130′, 130″ that is formed as a tube and has an MD length and a CD width formed by a spirally wound strip of material 110, 110′, 110″ that has a width that is less than the CD width of the base fabric 130, 130′, 130″ and includes at least one system of MD oriented yarns 112, 112a, 112b held in position by an additional fabric material component, which can be, for example, a system of CD oriented yarns 116, 116a, 116b, or any other suitable non-woven component, such as a suitable non-woven scrim. The spirally wound material strip 110, 110′, 110″ can be woven or non-woven.

As shown in box 84, the method further includes removing the additional fabric material component 116, 116a, 116b from the MD oriented yarns 112, 112a, 112b in the CD oriented fold regions 132, 134 at opposing MD ends of the tube to form respective seam regions 138.

As shown in box 86, the method further includes interweaving respective CD yarns 142 across a CD width of the base fabric 130, 130′, 130″ with the MD oriented yarns 112, 112a in the seam regions 138 to form respective woven regions 143 that are adapted to be located adjacent to the seam loops 114 formed by bent-back regions of the MD oriented yarns 112, 112a at each of the CD fold regions 132, 134 in the finished seamed press felt 100, 100′, 100″.

As shown at box 88, the method can optionally include interweaving spacer yarns 149 with the MD oriented yarns 112, 112a in a seam loop forming area 140 between the woven regions 143 at each of the CD fold regions 132, 134.

As shown at box 90, the method can then further include collapsing the tube such that the MD oriented yarns 112, 112a in the base fabric 130, 130′, 130″ are arranged as two superimposed layers connected by the bent-back regions of the MD oriented yarns 112, 112a that form the seam loops 114 at the seam areas 140 at the two opposing ends defined by the fold regions 132, 134.

As shown at box 92, the method further includes removing the spacer yarns 149, if present, from the MD oriented yarns 112, 112a at the seam loop forming area 140 such that the seam loops 114 are formed uniformly across the CD width of the press felt 100, 100′, 100″.

Additionally, as shown at box 94, in order to form the press felt 100, 100′, 100″, a pintle 118 is inserted through a pintle channel 119 defined by intermeshing the seam loops 114 from the two opposing ends defined by the CD fold regions 132, 134 to form the seam.

The method can optionally include stabilizing the woven regions 143 by interweaving a bi-component, at least partially meltable CD yarn 147 adjacent to the additional fabric material component 116, 116a, 116b that borders the woven regions 143 at CD oriented fold regions 132, 134. The method may then further include at least partially melting the bi-component, at least partially meltable CD yarns 147 to anchor the woven regions 143 to the additional fabric material component 116, 116a, 116b that borders the woven regions 143 at the CD oriented fold regions 132, 134.

Additionally, the method can also optionally include stabilizing the woven regions 143 using a material strip 148, which can be, for example, an at least partially meltable scrim.

In addition and/or alternatively, the method can further include stabilizing the woven regions 143 using a heat-activated adhesive layer which could be placed similarly to the material strip 148, as described above.

Additionally, the method preferably includes needling a fibrous batt 150 to the base fabric 130, 130′, 130″ and the woven regions 143 at each of the CD fold regions 132, 134 in order to provide a uniform surface to the press felt 100, 100′, 100″ including across the seam region.

According to the invention, the CD yarns 142 interwoven at the woven regions 143 adjacent to the seam is done in the base fabric 130, 130′, 130″ prior to the formation of the seam loops 114. The CD yarns 142 that are interwoven across a CD width of the base fabric 130, 130′, 130″ preferably include at least one stuffer yarn 144 as discussed above in order to enhance batt attachment. Further, the temporary yarns (spacer yarns 149) are also woven at the same time in order to temporarily hold a space that will form the seam loops 114 once these spacer yarns 149 are removed. This can be done in the base fabric 130, 130′, 130″ prior to collapsing the fabric loop in order to achieve the desired spacing. Additionally, anchoring using, for example, stitching yarns 146 can also be done at this point.

By weaving these complete seam forming regions 138 into the base fabric 130, 130′, 130″, a more uniform seam is formed even in spirally wound base fabrics 130, 130′, 130″ where the seam loops 114 extend in a true MD and are also vertical with respect to a horizontal plane defined by the base fabric 130, 130′, 130″. Further, using these woven areas 143, a crimped seam region can be provided in a non-crimped woven body of the base fabric 130, 130′, 130″ or in a non-woven used as the base fabric. This creates a higher crimped seam area in comparison to a low crimped woven body. This enhances retention of the batt fibers in the seam area in comparison to the prior known seams.

Further benefits of the present seam formation are that there is no tilt or skew in the weave in the seam regions resulting in seam loops 114 that are uniform rather than being angled not only with respect to true MD but with respect to vertical in comparison with a horizontal plane of the base fabric 130, 130′, 130″. This perpendicular orientation of the MD yarn loops is accomplished by replacing the angled diagonal yarns formed by the spirally wound strip 110, 110′, 110″ with interwoven true CD direction yarns 142 which force the MD yarns 112, 112a into a true MD direction in these areas.

This results from weaving what would be a non-multiaxial seam into a multi-axial cloth, achieving the cost saving benefits of multi-axial fabrics while providing the strength and ease of seaming of a traditionally woven fabric where the entire fabric is woven to the true CD width of the press felt.

Further benefits of the present invention are the resistance to tension stretching of the seam loops based on the true orientation of the seam loops 114 in the MD while the prior known multiaxial press felts typically have seam loops oriented at about 85° to 95° from the cross direction defined by the seam due to the spiral winding of the MD yarns.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A seamed press felt comprising:
a base fabric having an MD length and CD width, and including at least MD oriented yarns held in position by an additional fabric material component, the MD oriented yarns being arranged in the base fabric as two superimposed layers joined by bent-back regions of the MD oriented yarns at CD oriented fold regions at each of the two opposing ends thereof, the additional fabric material component being removed from the MD oriented yarns in the CD oriented fold regions to form seam regions,
respective CD yarns interwoven across a CD width of the base fabric with the MD oriented yarns in each of the superimposed layers in the CD oriented fold regions that form respective woven regions located adjacent to seam loops formed by the bent-back regions of the MD oriented yarns at the CD fold regions,
the woven regions anchoring the MD oriented yarns at the CD oriented fold regions such that the seam loops are formed uniformly across a CD width of the press felt, and
a pintle extending through a channel defined by intermeshing the seam loops from the two opposing ends to form a seam.

2. The seamed press felt of claim 1, wherein the woven regions comprise a crimp interchange of the CD yarns with the MD oriented yarns that is doubled.

3. The seamed press felt of claim 1, wherein the base fabric comprises a spirally wound material strip having a width that is less than the CD width of the base fabric.

4. The seamed press felt of claim 3, wherein the spirally wound material strip comprises a bonded nonwoven material.

5. The seamed press felt of claim 3, wherein the spirally wound material strip comprises a woven material.

6. The seamed press felt of claim 3, wherein the woven regions anchor the MD oriented yarns at the CD oriented fold regions such that the seam loops extend in a true machine direction of the base fabric.

7. The seamed press felt of claim 1, wherein the seam area is oriented at 90 degrees to a machine direction of the press felt.

8. The seamed press felt of claim 1, wherein a diameter of the CD yarns in the woven regions is selected to maintain a consistent caliper between a body of the press felt and the seam regions.

9. The seamed press felt of claim 1, wherein at least some of the woven regions include a bi-component, at least partially meltable CD yarn adjacent to the additional fabric material component that borders the woven regions at the CD oriented fold regions.

10. The seamed press felt of claim 1, wherein the woven regions each include at least one stuffer yarn located adjacent to the seam loops formed by the MD oriented yarns at the CD fold regions.

11. The seamed press felt of claim 10, wherein the at least one stuffer yarn is a multi-filament yarn.

12. The seamed press felt of claim 1, wherein the woven regions each include at least 2 monofilament yarns interwoven with the MD oriented yarns.

13. The seamed press felt of claim 1, further comprising respective surface material strips connected to the woven regions.

14. The seamed press felt of claim 1, further comprising a batt needled to the base fabric and the woven regions.

15. A method of producing a seamed press felt comprising:
providing a base fabric formed as a tube having an MD length and CD width formed by a spirally wound material strip having a width that is less than the CD width of the base fabric and including at least MD oriented yarns held in position by an additional fabric material component;
removing the additional fabric material component from the MD oriented yarns in CD oriented fold regions at two opposing MD ends of the tube to form respective seam regions;
interweaving respective CD yarns across a CD width of the base fabric with the MD oriented yarns in the seam regions to form respective woven regions that are adapted to be located adjacent to seam loops formed by bent-back regions of the MD oriented yarns at each of the CD fold regions in the finished seamed press felt;
interweaving spacer yarns with the MD oriented yarns in a seam loop forming area between the woven regions at each of the CD fold regions;
collapsing the tube such that the MD oriented yarns in the base fabric are arranged as two superimposed layers connected by the bent-back regions of the MD oriented yarns that form the seam loops at the seam regions at the two opposing MD ends;
removing the spacer yarns from the MD oriented yarns at the seam loop forming area such that the seam loops are formed uniformly across a CD width of the press felt; and
inserting a pintle through a channel defined by intermeshing the seam loops from the two opposing ends to form a seam.

16. The method of claim 15, further comprising stabilizing the woven regions by interweaving a bi-component, at least partially meltable CD yarn adjacent to the additional fabric material component that borders the woven regions at the CD oriented fold regions, and at least partially melting the bi-component, at least partially meltable CD yarns to anchor the woven regions to the additional fabric material component that borders the woven regions at the CD oriented fold regions.

17. The method of claim 15, further comprising stabilizing the woven regions by using an at least partially meltable scrim.

18. The method of claim 15, further comprising stabilizing using a heat activated adhesive layer.

19. The method of claim 15, further comprising needling a batt to the base fabric and the woven regions at each of the CD fold regions.
